(19) United States
(12) Patent Application Publication
(10) Pub. No.: US 2026/0366455 A1
(43) Pub. Date: Nov. 19, 2026

(54) PRESSURIZED GAS ROTATIONAL ASSIST FOR TURBOCHARGER COMPRESSORS

(71) Applicant: Daniel SNYDER, Latrobe, PA (US)

(72) Inventor: Daniel SNYDER, Latrobe, PA (US)

(21) Appl. No.: 19/386,405

(22) Filed: Nov. 12, 2025

Related U.S. Application Data
(60) Provisional application No. 63/806,327, filed on May 15, 2025.

(51) Int. Cl. F02B 39/08; F02B 37/12; F02B 37/16; F02B 37/24; F02D 41/00; F02D 41/10; F04D 27/02

(52) U.S. Cl. CPC F02B 39/085; F02B 37/12; F02D 41/0007; F02B 2037/122; F02B 37/162; F02B 37/24; F02D 41/10; F04D 27/0238

(57) ABSTRACT

An apparatus for reducing turbo lag in a turbocharger compressor. A pressurized gas source is configured to store gas. A regulator is fluidly coupled to the pressurized gas source, the regulator configured to control a pressure and a flow rate of said gas. A compressor housing defines an injection port, the injection port positioned to direct the pressurized gas jet toward blades of a compressor wheel. An injection mechanism is coupled to the injection port, the injection mechanism configured to inject the pressurized gas into the compressor housing such that the pressurized gas acts as a mechanical aid to provide rotational assistance to the compressor wheel.

### CROSS-REFERENCE TO RELATED APPLICATIONS

The present invention claims benefit of U.S. Provisional Application Ser. No. 63/806,327, filed May 15, 2025, the contents of which are incorporated herein by reference.

### FIELD OF THE INVENTION

This invention relates to turbocharger compressors, specifically to an apparatus and method for providing pressurized gas rotational assistance to enhance compressor performance.

### DESCRIPTION OF RELATED ART

Turbocharger compressors are widely used in internal combustion engines to improve performance by increasing the engine's air intake, leading to more efficient combustion. Traditional turbochargers rely on exhaust gases to drive the turbine, which in turn drives the compressor. However, this method can suffer from lag, as it takes time for exhaust gases to build up sufficient pressure to drive the turbine effectively.

Prior art teaches turbocharger airflow enhancement. For example, U.S. Patent Application Publication No. 2006/0130479 injects blow-by gases for emission control and U.S. Patent Application Publication No. 2007/0271921 provides ported-shroud passages to reduce compressor surge. U.S. Pat. No. 9,482,240 employs shroud or recirculation ports to stabilize airflow. Of note is that the prior art does not teach the use of injected gas to aid mechanical rotation of the compressor impeller, but rather airflow is supplemented for re-circulation purposes. The present system utilizes an independent source of stored, high-pressure gas to mechanically accelerate the compressor wheel and reduce turbo lag.

Existing solutions have also attempted to mitigate turbo lag through various means, such as variable geometry turbochargers and electric assist systems. Despite these advancements, there remains a need for an improved method to reduce lag and enhance the responsiveness of turbochargers by providing rotational assistance to the compressor wheel.

### SUMMARY OF THE INVENTION

It is the objective of the present invention that provides a housing injection port positioned and oriented to deliver gas tangentially or orthogonally into the compressor wheel's airflow path, producing direct rotational assistance. The injected gas may be directed at or adjacent to a splitter vane to create a targeted torque effect that enhances compressor wheel acceleration.

Unlike traditional turbochargers that rely solely on exhaust gases to drive the turbine, the method of the instant invention comprises the step of introducing pressurized gas directly to the compressor side. This approach significantly reduces turbo lag, improves throttle response, and enhances engine performance. The apparatus of the system is designed to be easily integrated into existing turbocharger setups, offering a cost-effective solution to boost efficiency and help get to peak power quicker.

Accordingly, comprehended is an apparatus for reducing turbo lag in a turbocharger compressor, comprising: a gas source configured to store a gas and deliver a pressured gas jet; a regulator fluidly coupled to the gas source, the regulator configured to control a pressure and a flow rate of the gas; a compressor housing including a compressor wheel; an injection port defined within the compressor housing; an injection mechanism disposed within the injection port, the injection mechanism configured to inject the gas into the compressor housing such that the gas provides rotational assistance to the compressor wheel. The compressor housing has a housing wall and a volute, the volute defined between the housing wall and the compressor wheel; the compressor wheel having plurality of blades; and, the injection port having a port axis extending through the housing wall and communicating with the volute, the injection port configured to deliver the pressurized gas jet tangentially into a flow path of the blades of the compressor wheel. More particularly, the compressor wheel within the compressor housing includes a plurality of blades thereon, each blade having a main vane and, optionally, a splitter vane. The housing wall and the plurality of blades define a volute within the compressor housing. An outer inlet opening is defined at the housing wall. An inner outlet aperture opens into the volute; and, wherein the injection port is defined at the housing wall between the outer inlet opening and the inner outlet aperture opening into the volute, the injection port thereby positioned to allow for a passage of gas directed toward the blade.

An electronic control unit (ECU) communicates with a vehicle control network, the ECU configured to monitor parameters of the vehicle control network, the parameters selected from the group consisting of engine speed, throttle position and boost pressure, wherein the ECU is adapted to control timing and duration of the gas based on the parameters.

The method of reducing turbo lag in a turbocharged engine, comprises the steps of: storing a pressurized gas in a tank; regulating a pressure and a flow rate of the pressurized gas; detecting an engine operating condition indicative of the turbo lag; injecting the pressurized gas into a compressor housing through an injection port oriented toward blades of a compressor wheel; and imparting rotational assistance to the compressor wheel with the pressurized gas.

### BRIEF DESCRIPTION OF THE DRAWINGS

FIG. 1 shows a flow chart of the prior art turbocharger process.

FIG. 2 shows a partial view in perspective of the compressor housing of the instant invention.

FIG. 3 shows a perspective view of the compressor wheel including blades plus an illustration of the injection mechanism acting thereon.

FIG. 4 shows a perspective view of a partial section of compressor housing.

FIG. 5 shows a different perspective view of a partial section of the compressor housing.

FIG. 6 shows a flow chart depicting the control logic of the electronic control unit (ECU).

### DETAILED DESCRIPTION OF THE INVENTION

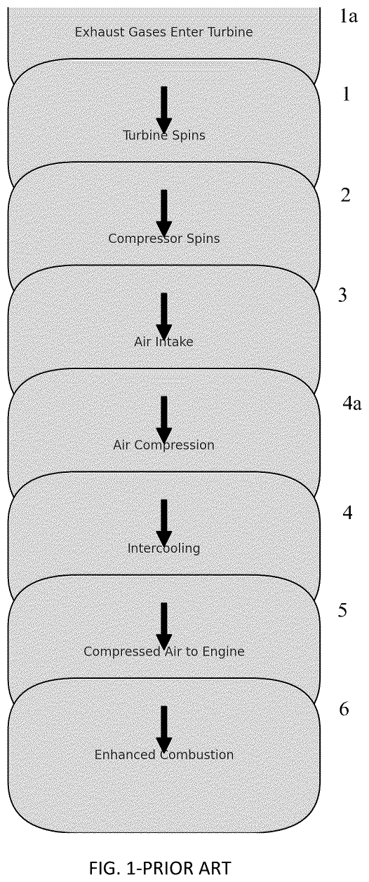

Referencing FIG. 1, a typical turbocharger includes a spinnable turbine 1 and a compressor 2. The turbine is within a turbine housing, and the compressor resides within a compressor housing, each generally comprising the whole turbocharger. The turbine includes a turbine wheel, and the turbine wheel is coupled with a compressor wheel on the same shaft. Exhaust gas is supplied to the turbine 1a and spins a turbine wheel which in turn spins the compressor wheel. The compressor wheel draws in air from the atmosphere to the compressor 3, and the drawn-in air is cooled 4, compressed and forced into an engine 5 to thereby enhance combustion 6. When there is not enough exhaust gas to spin the turbine wheel, lag, or turbo lag, occurs, and it decreases the performance of the turbocharger.

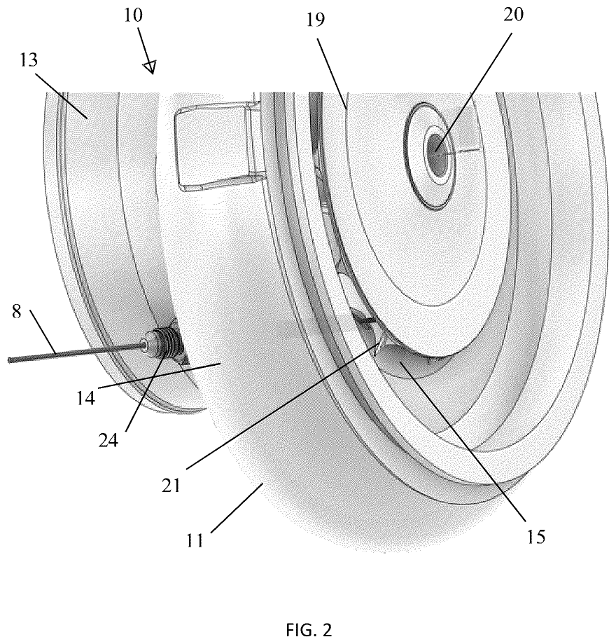

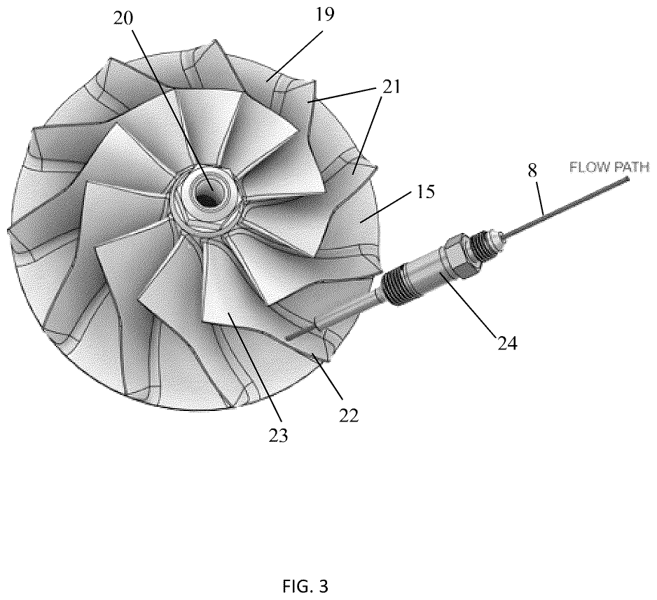

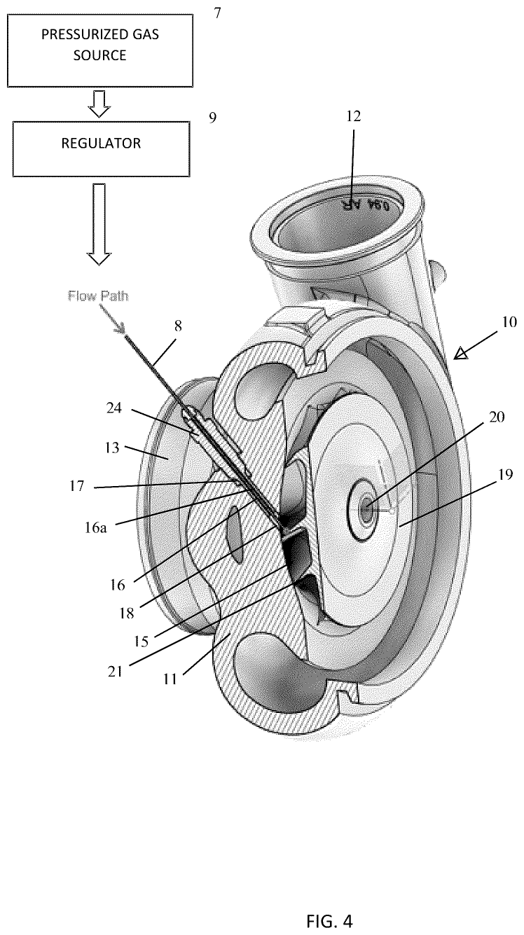

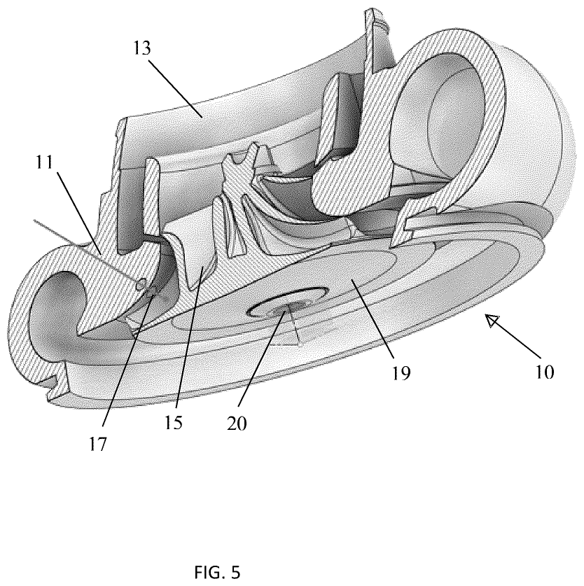

Now with reference to FIGS. 2-6, the present invention pertains to the compressor section 10 of the turbocharger. Herein provided is a pressurized gas rotational assist system for turbocharger compressors designed to improve turbocharger performance by introducing pressurized gas, i.e., a pressurized gas jet 8, from a gas source 7 directly into the compressor section 10 of the turbocharger thereby eliminating or minimizing lag. This system includes several key components, starting with the pressurized gas source 7, which is typically a tank or reservoir storing air, e.g., compressed air or nitrous oxide, or an inert gas at high pressure. In an exemplary embodiment, the tank preferably is a carbon-fiber air tank. Accordingly, the tank can be a scuba-style air tank, constructed from carbon fiber for lightweight strength and durability. The carbon fiber construction ensures a high strength-to-weight ratio. Mounting can be universal within the vehicle and location may vary depending on setup.

A regulator 9 is fluidly coupled to the gas source 7. The regulator 9 is employed and configured to control both the pressure and flow rate of the gas jet 8 being introduced into the system. In an exemplary embodiment, where the stored air, or pressurized gas, is, e.g., inert gas, the stored air is directly introduced into the compressor housing 11 and mechanically aids the spin of the compressor wheel 19, in turn, increasing the flow of inlet air to the compressor section 10. In another exemplary embodiment, where the stored air is, e.g., compressed air or nitrous oxide, the introduction of the stored air to the compressor housing 11 not only aids the spin of the compressor wheel 19 and in increasing the flow of inlet air to the compressor housing 11 but also provides additional oxygen to the compressor section 10, which will further increase the performance of the turbocharger.

As above, the entire turbocharger housing consists of two main sections, namely, the turbine section (not shown) and the compressor section 10. On the entire compressor section 10 of the turbocharger adjacent to the turbine section (not shown) is the compressor housing 11, plus the air discharge outlet 12 and the air inlet 13. As is known in the art, cooled, compressed air exits the air discharge outlet 12 after having been received from ambient air inlet 13 and after which the impeller or compressor wheel 19 with blades 21 has compressed the air, having been spun initially from the turbine wheel within the turbine housing (not shown). Turbine wheel (not shown) rotationally engages the compressor wheel 19 using a shaft (not shown) through shaft bore 20 and would thereby rotate compressor wheel 19 after the turbine wheel had exhaust gases acting thereon because the compressor wheel 19 sits on the opposite side.

Here, compressor housing 11 has a housing wall 14, i.e. its external casing. Opposite the housing wall 14 and interiorly would be the volute 15. As shown, the volute 15 is the space within the compressor housing 11 defined between the housing wall 14 and the compressor wheel 19, i.e. the compressor blades 21, which is generally spirally-shaped as a result of being partially defined by the compressor blades 21 such that airflow can be optimized and guided to air discharge outlet 12. Compressor blades 21 of compressor wheel 19 are in plurality along compressor wheel 19 as shown, and each blade 21 comprises a main vane 23 and, optionally, a splitter vane 22. Each blade 21 may comprise a main vane 23 and a splitter vane 22; however, in some embodiments, one or more blades 21 may be formed as a single, undivided vane that is not differentiated into a main vane 23 and a splitter vane 22 depending on design and desired aerodynamic surface therefor. Each splitter vane 22 is more proximate to outer diameter of compressor wheel 19, whereas each main vane 23 would be positioned radially around shaft and shaft bore 20. As is known, the larger main vanes 23 are more deformed and compress the incoming air. The smaller splitter vanes 22 focus on guiding and splitting the airflow. Herein, it should be understood that the angles of the splitter vanes 22 and main vanes 23 can vary. Compressor wheels 19 can vary based on turbocharger design and application. For example, the splitter vane 22 angle can be further tilted to aid mechanical force at lower shaft speeds. Modifying the splitter vane 22 can be done upon a pre-existing compressor wheel 19 or through a newly manufactured compressor wheel 19 with enhanced design features. The invention is not limited to a particular vane type, angle, size, etc. and can function with any type of compressor wheel 19. The compressor blades 21 may be modified as needed, e.g., machined, to enable the pressurized gas jet 8 to more effectively spin the compressor wheel 19.

Critically, an injection port 16 is defined within the compressor housing 11. The injection port 16 has a port axis 16a extending through the housing wall 14 and communicates with the compressor volute 15 adjacent the splitter vane 22. The injection port 16 is oriented substantially orthogonal to the radial plane of the splitter vane 22 and is configured to deliver a pressurized gas jet 8 tangentially into the flow path of the compressor wheel 19, i.e. “directly” at the compressor wheel. In an exemplary embodiment, although not limited thereto, “substantially orthogonal” means the injection port 16 extends along a linear port axis 16a that intersects the volute 15 at an angle of approximately 90 degrees ±10° relative to the splitter vane 22 surface. The port axis 16a may further form an acute angle (for example, between 15° and 30°) relative to the rotational plane of the compressor wheel 19 to promote circumferential mixing with the main compressor housing 11 flow.

The length of the injection port 16 is defined between an outer inlet opening 17, defined at the housing wall 14, adapted for coupling to a gas supply conduit of an injection mechanism 24, and an inner outlet aperture 18 opening into the volute 15. The length of injection port 16 may vary depending on the wall thickness of the compressor housing 11, the size of the compressor housing 11 and desired gas jet 8 penetration. The cross-sectional shape of the port 16 may be cylindrical, conical, or diffuser-shaped, optionally tapering from a larger outer diameter to a smaller inner exit to accelerate the injected pressurized gas jet 8. In some embodiments, the port 16 could be curved or arcuate, forming a venturi-type or scroll-shaped passage to direct the gas circumferentially along the splitter vane's leading face. The exit orientation is positioned such that the injected gas jet 8 flow also impinges or merges with the main compressor airflow proximate the splitter vane 22, thereby inducing a localized low-pressure region that promotes boundary-layer separation control and improved compressor efficiency.

An injection mechanism 24 is disposed within, i.e. coupled to, the injection port 16. The injection mechanism 24 provides the gas jet 8 through the injection port 16, e.g., coming from the gas source 7. The injection mechanism 24 comprises the strategically placed nozzles or injectors within the compressor housing 11. In an exemplary embodiment the injection mechanism is a solenoid-actuated nozzle. The nozzle ensures that any gas is distributed evenly, aiding in the mechanical driving of the compressor wheel 11. As a result, in conjunction with exhaust gas spinning the turbine wheel, the injection mechanism 24 increases the performance of the turbocharger as it communicates with the injection port 16, through which the gas jet 8 is directed.

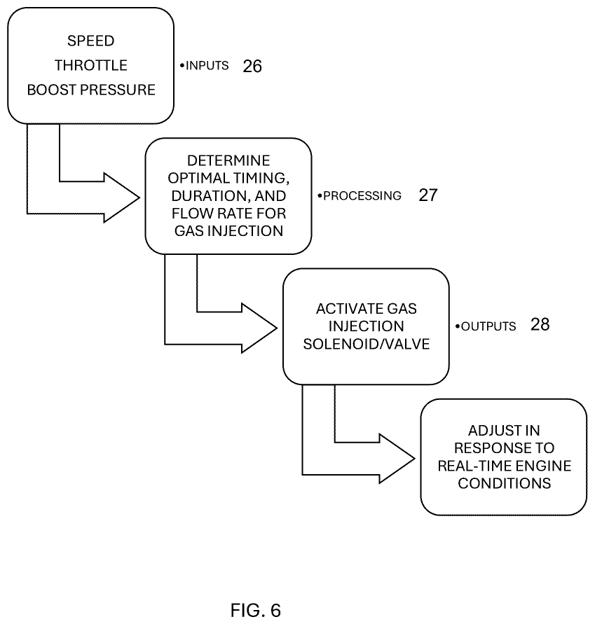

The system also incorporates a control system. The control system can be mechanical, hydraulic, pneumatic, digital, hybrid, electro-mechanical or a remote or network-based control system. In the exemplary embodiment, the control system features an electronic control unit (ECU) 25 that communicates with the vehicle control network and monitors critical engine inputs/parameters 26, such as engine speed, throttle position, and boost pressure (see FIG. 6). The ECU 25 controls processing 27 by adjusting the timing and duration of gas injection based on real-time data, optimizing performance and reducing turbo lag. Additionally, the system outputs 28 can be tailored by the end user, allowing them to adjust the gas control solenoid or device as desired. The control logic of the electronic control unit (ECU) 25 can be implemented in circuitry, digital electronic circuitry, computer software, firmware, or hardware, or any combination thereof. The logic executes the operations described in the control flow, including receiving sensor inputs, processing engine parameters, determining optimal gas injection timing and duration, activating control devices such as solenoids or valves, and continuously adjusting to real-time engine conditions.

The operations of the ECU 25 can be carried out by a data processing apparatus acting upon data stored in one or more computer-readable storage devices or received from other sensors and communication interfaces. The data processing apparatus can include a programmable processor, microcontroller, system-on-a-chip (SoC), or combinations thereof, configured to process the input signals and produce the described control outputs. In various embodiments, the ECU 25 can include circuitry or special-purpose logic circuitry such as a central processing unit (CPU), a field-programmable gate array (FPGA), an application-specific integrated circuit (ASIC), or a digital signal processor (DSP). The control logic can also be implemented using embedded firmware, processor-executable code, or hardware-based logic modules. The ECU 25 may include or interact with one or more software environments that support execution of the control logic, such as real-time operating systems (RTOS), embedded operating systems, or virtualized control platforms. These environments can include communication protocols, driver stacks, and memory management systems that facilitate data acquisition and output control.

Embodiments can also employ networked computing devices that communicate through wired or wireless digital data connections, such as a vehicle communication bus (e.g., CAN bus, LIN, or Ethernet). The ECU 25 can operate as a standalone module or as part of a distributed engine management system communicating with other controllers, sensors, or mobile diagnostic devices, so “vehicle control network” is meant to define all components of the engine management system.

In one embodiment, the ECU 25 can be configured for remote calibration, tuning, or data acquisition. A mobile device or remote terminal can interface with the ECU 25 to adjust the inputs 26, processing 27, outputs 28 and to adjust any other parameters, retrieve performance data, or update the control logic. This allows the described turbocharger control process—monitoring engine conditions, determining optimal gas injection parameters, and dynamically adjusting operation—to be performed locally by the ECU 25 or remotely through a connected client device.

The system is designed for seamless integration with existing turbocharger setups, making it easily adaptable to a wide range of vehicles. A retrofit kit can be provided for aftermarket installations.

During operation, the system activates when conditions conducive to turbo lag are detected, such as rapid throttle application or low engine speeds. Upon activation, the regulator adjusts the flow rate of the pressurized gas based on instructions from the ECU 25. The gas jet 8 is then injected into the compressor housing 11, directly aiding the compressor wheel 19 by increasing its acceleration and reducing the time required to build boost pressure. This immediate rotational assistance is mechanical and significantly reduces turbo lag, enhancing throttle response and overall engine performance, particularly during transient conditions when traditional turbochargers struggle. The system ultimately improves engine efficiency and power output, the main advantages including a significant reduction in turbo lag, improved throttle response, and enhanced engine performance without merely the increase of the air flow but through mechanical aid.

By maintaining optimal boost pressure more consistently, the system ensures a more efficient and responsive engine. Moreover, it offers a cost-effective solution, easily integrating with existing turbocharger systems, making it an attractive option for improving turbocharged engine performance without the need for extensive modifications.

1. (canceled)

2. (canceled)

3. (canceled)

4. (canceled)

5. (canceled)

6. An apparatus for reducing turbo lag in a turbocharger compressor, comprising:
a gas source configured to store a gas and deliver a high-pressure gas jet;
a regulator fluidly coupled to said gas source, said regulator configured to control a pressure and a flow rate of said high-pressure gas jet;
an injection mechanism in continuous fluid communication with said gas source through said regulator, said injection mechanism configured to convey said high-pressure gas jet to an injection port and to deliver said high-pressure gas jet at a pressure and flow rate controlled by said regulator;
a compressor housing having a housing wall;
a compressor wheel within said compressor housing, said compressor wheel including a plurality of blades thereon, each said blade having a main vane and a splitter vane;
said housing wall and said plurality of blades defining a volute within said compressor housing;
an outer inlet opening defined at said housing wall;
an inner outlet aperture opening into said volute; and,
said injection port coupled to said injection mechanism, wherein said injection port is defined at said housing wall between said outer inlet opening and said inner outlet aperture opening into said volute, said injection port thereby positioned to allow for a passage of gas directed toward at least one of said plurality of blades, said injection port having a port axis oriented substantially orthogonal to a radial plane of said splitter vane, said port axis forming an acute angle relative to a rotational plane of said compressor wheel, said injection port having a cross-sectional shape tapering from a larger outer diameter at said outer inlet opening to a smaller inner exit at said inner outlet aperture to accelerate said high-pressure gas jet, wherein said high-pressure gas jet provides rotational assistance to said compressor wheel.

7. (canceled)

8. (canceled)

9. (canceled)

10. (canceled)

11. The apparatus of claim 6, wherein said gas source is a tank, and wherein said gas is selected from the group consisting of compressed air, nitrous oxide and an inert gas.

12. (canceled)

13. The apparatus of claim 6, further comprising an electronic control unit (ECU) communicating with a vehicle control network, said ECU configured to monitor parameters of said vehicle control network, said parameters selected from the group consisting of engine speed, throttle position and boost pressure, wherein said ECU is adapted to control timing and duration of said gas based on said parameters.

14. A method of reducing turbo lag in a turbocharged engine, comprising the steps of:
storing a pressurized gas in a tank;
regulating a pressure and a flow rate of said pressurized gas with a regulator in continuous fluid communication with said tank;
detecting an engine operating condition indicative of said turbo lag;
conveying said pressurized gas from said tank, through said regulator, to an injection port defined in a compressor housing;
injecting said pressurized gas into said compressor housing through said injection port oriented toward blades of a compressor wheel; and
imparting rotational assistance to said compressor wheel with said pressurized gas delivered as a high-pressure gas jet at a pressure and flow rate controlled by said regulator, said high-pressure gas jet exiting said injection port directly at said compressor wheel.

15. The method of claim 14, further comprising the step of modifying said blades to enable said pressurized gas to more effectively spin said compressor wheel.

16. The method of claim 15, wherein for the step of modifying said blades, a splitter vane angle is changed.

17. The method of claim 14, further comprising the step of introducing stored air to said compressor housing, wherein additional oxygen increases performance of said turbocharged engine.
